(19) United States
(12) Patent Application Publication
(10) Pub. No.: US 2026/0326541 A1
(43) Pub. Date: Oct. 22, 2026

(54) SHIFT KNOB

(71) Applicant: TOYOTA JIDOSHA KABUSHIKI KAISHA, Toyota-shi (JP)

(72) Inventors: Satoshi YAMAMICHI, Nagoya-shi (JP); Kei YAMAMOTO, Toyota-shi (JP)

(73) Assignee: TOYOTA JIDOSHA KABUSHIKI KAISHA, Toyota-shi (JP)

(21) Appl. No.: 19/545,240

(22) Filed: Feb. 20, 2026

(30) Foreign Application Priority Data
Apr. 18, 2025 (JP) 2025-069069

(51) Int. Cl. B60K 20/02

(52) U.S. Cl. CPC B60K 20/02

(57) ABSTRACT

A shift knob includes a pair of left and right side portions having a front side inclined portion inclined toward the vehicle rear upper side when viewed from the vehicle width direction and a rear side inclined portion inclined toward the vehicle front upper side, and a concave portion formed between the left and right front side inclined portions and between the left and right rear side inclined portions and having a rectangular shape when viewed from the vehicle front-rear direction.

### CROSS-REFERENCE TO RELATED APPLICATION

This application claims priority to Japanese Patent Application No. 2025-069069 filed on Apr. 18, 2025. The disclosure of the above-identified application, including the specification, drawings, and claims, is incorporated by reference herein in its entirety.

### BACKGROUND

### 1. Technical Field

The present disclosure relates to a shift knob.

### 2. Description of Related Art

A shift knob provided at an appropriate position in a vehicle cabin of an automobile and configured to be operable in a vehicle front-rear direction by a driver has been conventionally known (see Japanese Unexamined Patent Application Publication No. 2019-071218 (JP 2019-071218 A), for example).

### SUMMARY

When a handle of a bag body can be hung on the shift knob, there is a possibility that an unintended shift operation may be caused by the weight of the contents of the bag body or the contact of a seat with the bag body at the time of sliding the sheet. Therefore, it is desirable that the shift knob should have a shape with which it is difficult to hang the handle of the bag body on the shift knob while suppressing a decrease in the operability of the shift knob.

Therefore, an object of the present disclosure is to obtain a shift knob on which it is difficult to hang a handle of a bag body while suppressing a decrease in the operability of the shift knob.

In order to achieve the above object, a first aspect of the present disclosure provides a shift knob including: a pair of right and left side portions each including:
a front side inclined portion inclined toward a vehicle rear upper side when viewed from a vehicle width direction and a rear side inclined portion inclined toward a vehicle front upper side; and
a recess provided in at least one of a space between right and left front side inclined portions and a space between right and left rear side inclined portions, the recess having a rectangular shape when viewed from a vehicle front-rear direction.

According to the first aspect of the present disclosure, the shift knob includes a pair of right and left side portions each including a front side inclined portion inclined toward a vehicle rear upper side when viewed from a vehicle width direction and a rear side inclined portion inclined toward a vehicle front upper side. Therefore, even when a handle of a bag body is hung on the shift knob, the handle is likely to be slid toward the vehicle upper side due to the side portions, and is likely to come off. That is, it is difficult to hang the handle of the bag body on the shift knob. Further, a recess is provided in at least one of a space between right and left front side inclined portions and a space between right and left rear side inclined portions, the recess having a rectangular shape when viewed from a vehicle front-rear direction. Therefore, a finger is easily inserted between the right and left side portions, and a decrease in the operability of the shift knob is suppressed.

A shift knob according to a second aspect of the present disclosure is the shift knob according to the first aspect,in which

the recess is provided between the right and left front side inclined portions and between the right and left rear side inclined portions, each recess having a rectangular shape in a plan view.

According to the second aspect of the present disclosure, the recess is formed between the right and left front side inclined portions and between the right and left rear side inclined portions, each recess having a rectangular shape in a plan view. Therefore, a finger is more easily inserted between the right and left side portions, and a decrease in the operability of the shift knob is suppressed.

A shift knob according to a third aspect of the present disclosure is the shift knob according to the first or second aspect, in which

at least an upper end portion of the side portions has a tapered surface when viewed from the vehicle front-rear direction.

According to the third aspect of the present disclosure, at least the upper end portion of the side portions has a tapered surface when viewed from the vehicle front-rear direction. Therefore, even when a handle of a bag body is hang on the shift knob, the handle is more likely to be slid toward the vehicle upper side, and is more likely to come off. That is, it is more difficult to hang the handle of the bag body on the shift knob.

As described above, the shift knob according to the present disclosure makes it difficult to hang a handle of a bag body on the shift knob while suppressing a decrease in the operability of the shift knob.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a shift knob according to the present embodiment;

FIG. 2 is a schematic perspective view illustrating a shift knob according to the present embodiment when viewed from another angle;

FIG. 3 is a schematic front view showing a shift knob according to the present embodiment;

FIG. 4 is a schematic plan view showing a shift knob according to the present embodiment;

FIG. 5 is a schematic side view showing a shift knob according to the present embodiment; and

FIG. 6 is a schematic cross-sectional view taken along an arrow X-X in FIG. 2 showing the configuration of the shift knob according to the present embodiment.

### DETAILED DESCRIPTION OF EMBODIMENTS

Hereinafter, an embodiment according to the present disclosure will be described in detail with reference to the drawings. For convenience of description, the arrow UP, the arrow FR, and the arrow RH appropriately shown in the figures indicate the upward direction of a vehicle, the forward direction of the vehicle, and the right direction of the vehicle, respectively. In addition, in the following description, when the vertical, front-rear, and left-right directions are described without special mention, the vertical, front-rear, and left-right directions of the vehicle are assumed to be indicated. Further, the right-left direction is synonymous with a vehicle width direction.

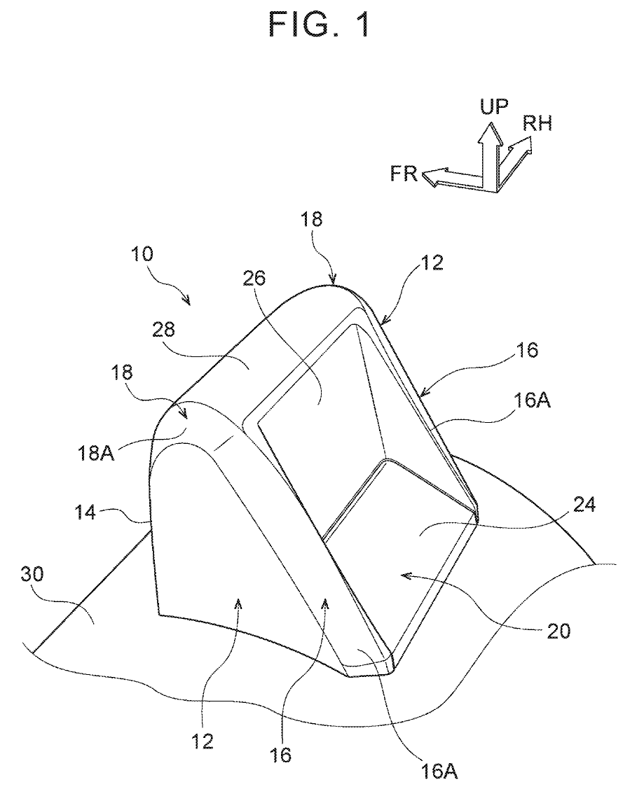

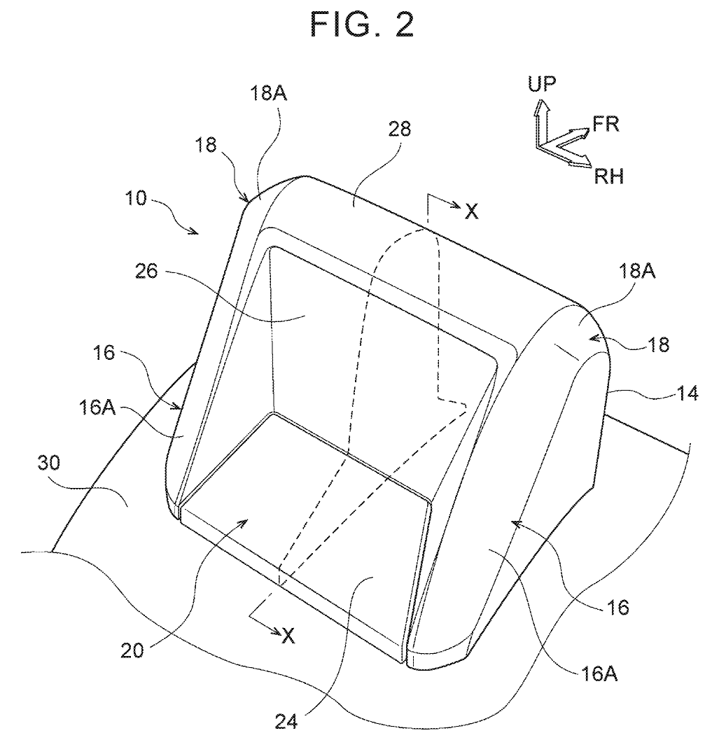

As shown in FIGS. 1, 2, 5, and 6, the shift knob 10 according to the present embodiment is provided, for example, in a center console (not shown) in a vehicle cabin of an automobile. The shift knob 10 is integrally formed on the upper surface of the substantially arc-shaped shift pedestal 30 protruding upward in a side cross-sectional view viewed from the vehicle width direction. The shift knob 10 (shift pedestal 30) is made of resin and is configured to be rotatable in the front-rear direction by a finger of a driver.

As shown in FIGS. 1 to 6, the shift knob 10 includes a front side inclined portion 14 that is inclined at a predetermined angle θ1 toward the rear upper side (front lower side) with respect to the shift pedestal 30 in a side view. The shift knob 10 includes a pair of left and right side portions 12 having rear side inclined portions 16 inclined at a predetermined angle θ2 to the front upper side (rear lower side) with respect to the shift pedestal 30.

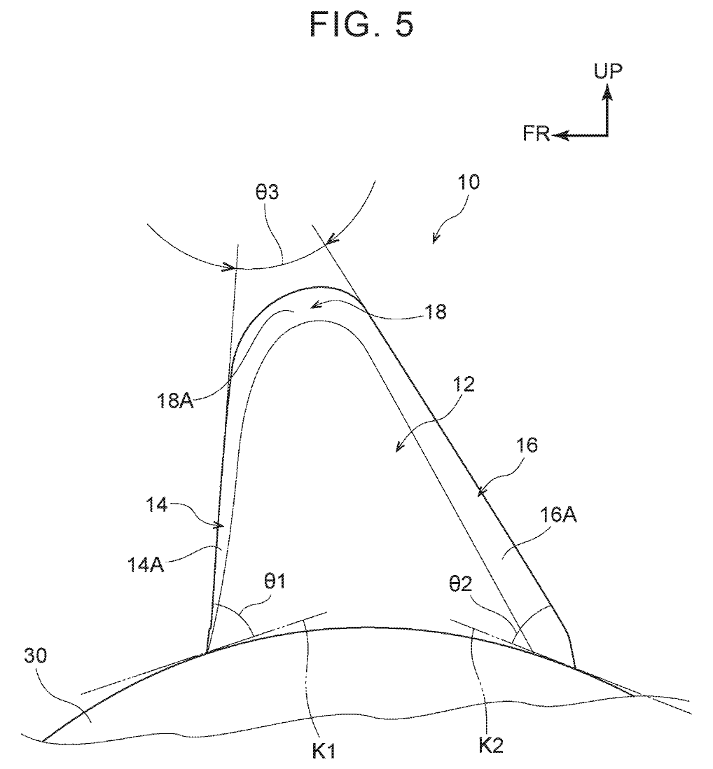

Note that the angle θ1 is an angle (θ1 > θ2) larger than the angle θ2, and the pair of left and right side portions 12 are formed to have a substantially acute triangular shape in a side view (see FIG. 5). In addition, "with respect to the shift pedestal 30" in the present embodiment means "with respect to the virtual tangential K1 of the shift pedestal 30 at the lower end of the front side inclined portion 14 or with respect to the virtual tangential K2 of the shift pedestal 30 at the lower end of the rear side inclined portion 16 in a side view" (see FIG. 5).

In addition, the upper end portion of the front side inclined portion 14 and the upper end portion of the rear side inclined portion 16 are integrally connected to each other to form an upper end portion of the side portion 12, and the upper end portion of the side portion 12 is a top portion 18. The top portion 18 is formed in a substantially arc shape in a side view. The angle θ3 formed by the front side inclined portion 14 and the rear side inclined portion 16 is, for example, 35 degrees to 38 degrees, and in the present embodiment, the angle θ3 is 36.6 degrees (see FIG. 5).

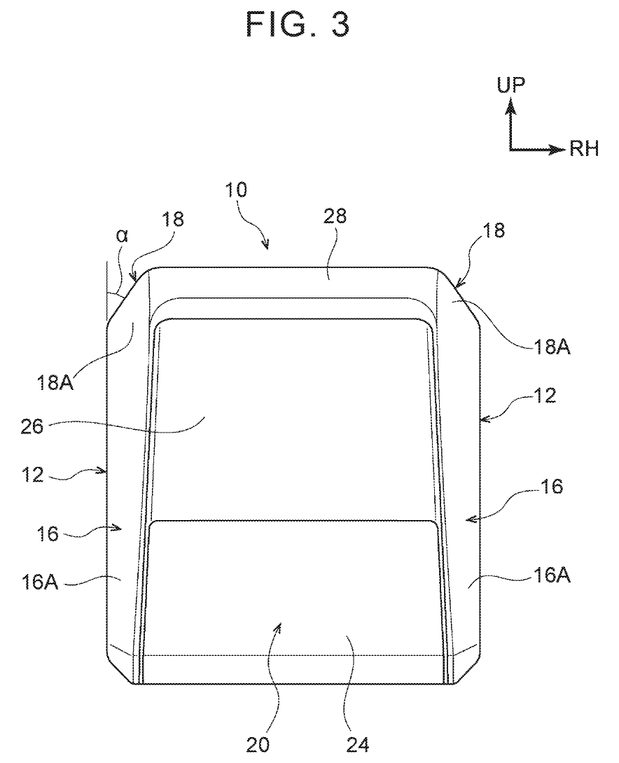

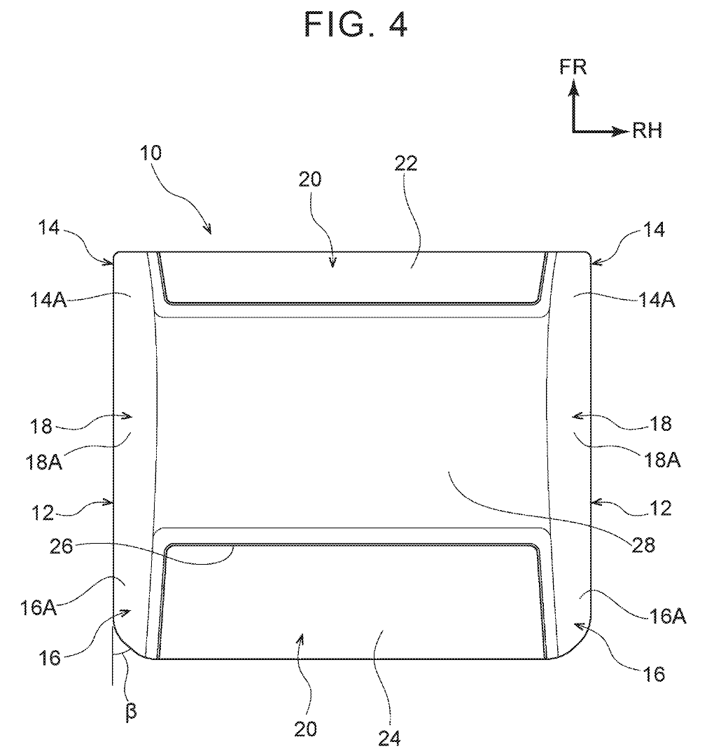

Further, the outer side of the top portion 18 in the left-right direction is a tapered surface 18A having a predetermined angle and a predetermined width when viewed from the front-rear direction (see FIG. 3). The front side inclined portion 14 and the rear side inclined portion 16 also have a tapered surface 14A and a tapered surface 16A of a predetermined angle and a predetermined width in a plan view (see FIG. 4). That is, the lateral outer sides of the front side inclined portion 14, the top portion 18, and the rear side inclined portion 16 have a tapered surface 14A, 18A, 16A of a predetermined angle and a predetermined width which are integrally connected to each other.

Incidentally, the angle α with respect to the vertical direction of the tapered surface 18A of the top portion 18 in the front view is, for example, an angle (α > β) larger than the angle β with respect to the front-rear direction of the tapered surface 16A of the rear side inclined portion 16 in the plan view. The angle α is referenced in FIG. 3. The angle β is referenced in FIG. 4. Further, the width of the tapered surface 18A of the top portion 18 is a width larger than the width of the tapered surface 14A of the front side inclined portion 14 and the width of the tapered surface 16A of the rear side inclined portion 16.

Further, the shift knob 10 according to the present embodiment includes a recess 20 formed at a predetermined depth between the left and right front side inclined portions 14 and between the left and right rear side inclined portions 16. The recess on the front side (hereinafter referred to as "front-side recess") 22 has a substantially rectangular shape in front view and in plan view, and the recess on the rear side (hereinafter referred to as "rear-side recess") 24 also has a substantially rectangular shape in front view and in plan view.

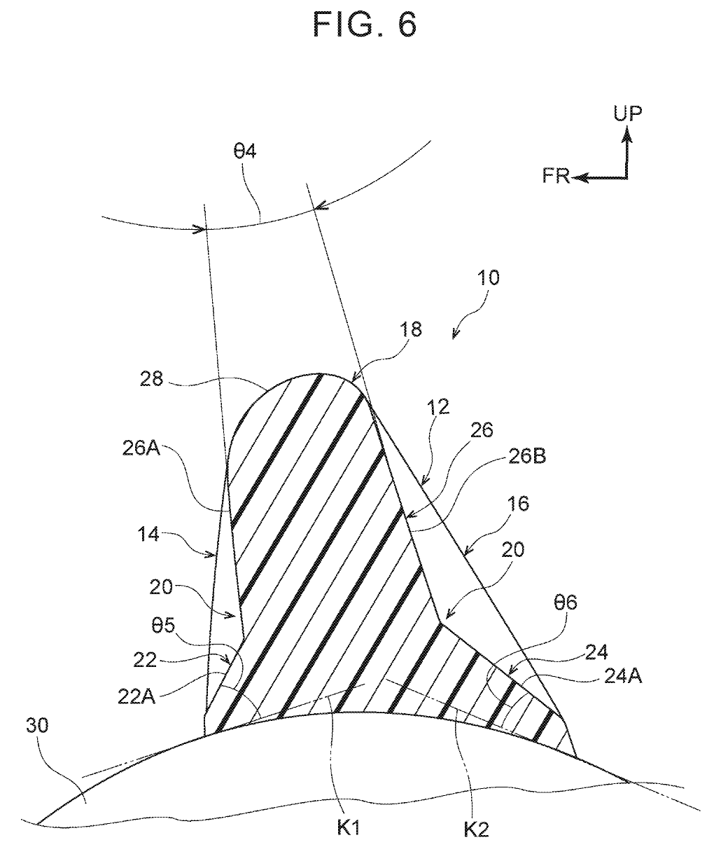

That is, the shift knob 10 is formed in a substantially "H" shape in plan view, and is formed in a shape having a substantially rectangular flat plate-shaped operation portion 26 having a predetermined thickness between the pair of left and right side portions 12. The height of the top portion 28 of the operation portion 26 and the height of the top portion 18 of the side portion 12 are the same. Further, the angle θ4 formed between the front 26A and the rear 26B of the operation portion 26 is, for example, 10 degrees to 12 degrees, and in the present embodiment, the angle θ4 = 11.0 degrees (see FIG. 6).

The bottom surface 22A of the front-side recess 22 is an inclined surface inclined at a predetermined angle θ5 with respect to the shift pedestal 30 in a side cross-sectional view. The bottom surface 24A of the rear-side recess 24 is an inclined surface inclined at a predetermined angle θ6 with respect to the shift pedestal 30 in a side cross-sectional view. The angle θ6 of the bottom surface 24A of the rear-side recess 24 is set to an angle smaller than the angle θ2, and the angle θ5 of the bottom surface 22A of the front-side recess 22 is set to an angle (θ1 > θ5 > θ6) smaller than the angle θ1 and larger than the angle θ6 (see FIGS. 5 and 6).

Next, the operation of the shift knob 10 according to the present embodiment configured as described above will be described.

As described above, the shift knob 10 according to the present embodiment includes a pair of left and right side portions 12 having a front side inclined portion 14 inclined toward the rear upper side and a rear side inclined portion 16 inclined toward the front upper side in a side view. Therefore, even when the handle (not shown) of the bag body is hooked on the shift knob 10, the handle is easily slipped upward and easily detached by the side portion 12. That is, it is difficult to hook the handle of the bag body to the shift knob 10.

In addition, in a front view, the outer side of the top portion 18 of the side portion 12 in the left-right direction has a tapered surface 18A having a predetermined angle and a predetermined width. In a plan view, the front side inclined portion 14 and the rear side inclined portion 16 of the side portion 12 have a tapered surface 14A and a tapered surface 16A of a predetermined angle and a predetermined width, respectively. Therefore, even when the handle of the bag body is hooked on the shift knob 10, the handle is more easily slipped upward and easily detached. In other words, it is more difficult to hook the handle of the bag body to the shift knob 10.

In this case, it is more effective when the angle α at the top portion 18 of the side portion 12 is, for example, an angle larger than the angle β at the rear side inclined portion 16 of the side portion 12. Further, when the width of the tapered surface 18A at the top portion 18 of the side portion 12 is larger than the width of the tapered surface 14A at the front side inclined portion 14 of the side portion 12 and the width of the tapered surface 16A at the rear side inclined portion 16, it is more effective. Further, when the angle θ3 formed by the front side inclined portion 14 and the rear side inclined portion 16 of the side portion 12 is at the above-described angle, for example, a sleeve of a garment is less likely to be caught, which is more effective.

Further, in the shift knob 10 according to the present embodiment, between the left and right front side inclined portions 14 and between the left and right rear side inclined portions 16, a recess 20 having a predetermined depth that forms a substantially rectangular shape in front view and in plan view is formed. That is, the front-side recess 22 is formed between the left and right front side inclined portions 14, and the rear-side recess 24 is formed between the left and right rear side inclined portions 16.

Therefore, the finger is easily inserted between the pair of left and right side portions 12, and the finger is easily hooked on the front 26A and the rear 26B of the operation portion 26. Therefore, it is possible to suppress a decrease in operability with respect to the shift knob 10. It should be noted that the angle θ4 formed by the front 26A and the rear 26B of the operation portion 26 is more effective when the angle is set to the above-described angle.

The shift knob 10 according to the present embodiment has been described above with reference to the drawings. However, the shift knob 10 according to the present embodiment is not limited to the illustrated one, and can be appropriately changed in design without departing from the gist of the present disclosure. For example, the angle and width of the tapered surface 14A, 18A, 16A integrally formed on the lateral outer sides of the front side inclined portion 14, the top portion 18, and the rear side inclined portion 16 are not limited to the illustrated angle and width. Further, it is desirable that a tapered surface 18A having a predetermined angle-width is formed at least on the lateral outer side of the top portion 18.

Further, the recess 20 may be configured to be formed only in the front-side recess 22 or only in the rear-side recess 24. That is, the recess 20 may be formed in at least one of the left and right front side inclined portions 14 and the left and right rear side inclined portions 16. In addition, the recess 20 (the front-side recess 22 and the rear-side recess 24) may have a substantially rectangular shape in at least a front view. That is, the recess 20 (the front-side recess 22 and the rear-side recess 24) may be formed in, for example, a substantially semicircular shape in which the outer side in the front-rear direction is substantially arcuate in plan view.

What is claimed is:

1. A shift knob comprising:
a pair of right and left side portions each including a front side inclined portion inclined toward a vehicle rear upper side when viewed from a vehicle width direction and a rear side inclined portion inclined toward a vehicle front upper side; and
a recess provided in at least one of a space between right and left front side inclined portions and a space between right and left rear side inclined portions, the recess having a rectangular shape when viewed from a vehicle front-rear direction.

2. The shift knob according to claim 1, wherein the recess is provided between the right and left front side inclined portions and between the right and left rear side inclined portions, each recess having a rectangular shape in a plan view.

3. The shift knob according to claim 1, wherein at least an upper end portion of the side portions has a tapered surface when viewed from the vehicle front-rear direction.
